(19) United States
(12) Patent Application Publication
(10) Pub. No.: US 2015/0162957 A1
(43) Pub. Date: Jun. 11, 2015

(54) Scanning station utilizing passive near-field communication RF coupling system for scanning RFID tags

(71) Applicant: WaveMark, Inc., Littleton, MA (US)

(72) Inventors: Jean-Claude J. Saghbini, Cambridge, MA (US); Richard Leitermann, Arlington, MA (US); Michael J. Yetsko, Whitinsville, MA (US)

(21) Appl. No.: 14/097,741

(22) Filed: Dec. 5, 2013

(51) Int. Cl. H04B 5/00; H04B 5/02

(52) U.S. Cl. CPC H04B 5/0062; H04B 5/0087; H04B 5/02

(57) ABSTRACT

A system and method for scanning medical items having RFID tags in a medical care facility using a passive Near-Field Communication (“NFC”) RF coupling system within a scanning station. The RF coupling system forms a communications link between a primary NFC device acting as an RFID reader, such as a mobile device, and a secondary NFC device, an RFID tag attached to a medical item. The RF coupling system has a primary NFC antenna and a secondary NFC antenna connected by a transmission line. Using the RF coupling system, the scanning station relocates the active scanning area from the back of the mobile device to the secondary NFC antenna. The RF coupling system enables an effective distance between the primary and secondary NFC devices on the order of meters, corresponding to the wavelength of passive NFC devices operating at 13.56 Mhz, instead of 2-4 centimeters.

### BACKGROUND OF THE INVENTION

Radio-frequency identification (RFID) is the use of a wireless non-contact system that generates radio-frequency electromagnetic fields to transfer data from an RFID tag attached to an object. Industry typically utilizes RFID tags for the purposes of identification and tracking of goods in the supply chain, also known as asset or supplies management. An emerging area of RFID technology is for creation of “smart hospitals” that enable tracking of medical items having RFID tags in healthcare settings.

An RFID tag contains electronically stored information, and provides its information in response to a request from an RFID reader. While some applications utilize RFID tags that include their own power source such as a battery, known as active RFID tags, many RFID tags have no power source. These are also known as passive RFID tags.

The advent of data networking technologies and the internet, combined with the widespread adoption of mobile device technology, spawned an extension of RFID technology, known as Near-field Communication (“NFC”). NFC is based on inductive coupling, where loosely coupled inductive circuits share power and data over a maximum distance of 4 centimeters (“cm”). NFC devices share the same basic technology as passive RFID tags.

Mobile devices such as cell phones and tablets include NFC transceiver computer chips that support both active and passive NFC modes. With either mode, NFC devices are able to receive and transmit data at the same time. An NFC-enabled mobile device is an RFID reader that allows an operator to “scan,” or read information from an RFID tag attached to an item.

An NFC-equipped mobile phone or tablet acting as an NFC transceiver, or RFID reader, forms a communications channel with another NFC-equipped device acting as an NFC receiver. This occurs when the devices are placed within close proximity to one another. The NFC transceiver is known as the primary NFC device, and the NFC receiver is known as the secondary NFC device. One example of a secondary NFC device is an RFID tag. Another example of a secondary NFC device is a second mobile device.

### SUMMARY OF THE INVENTION

In medical facilities, it would be helpful to combine RFID-based networked inventory control, tracking, and reporting systems with the ubiquity, flexibility, and low-cost of NFC-enabled mobile devices as RFID readers. With this technology, medical facilities could track medical items from the time of reception at the facility to the point of consumption by a technician, doctor, or other medical professional.

Medical facilities could deploy scanning kiosks or stations at different locations in a hospital or clinical setting to perform the tracking. The scanning stations would also typically include a stand or pedestal that holds the mobile device that functions as the RFID reader in a stationary manner. Examples of mobile devices include mobile computing devices such as WiFi and/or cellular enabled smart phones and/or tablet computers and/or portable computers (running operating systems including IOS by Apple Corporation or the Android operating system by Google, Inc. or by operating systems by Microsoft Corporation).

The scanning stations would identify and track medical items at each phase of their usage, which often corresponds to the locations in the medical facility where the medical items enter and exit the custody and control of each medical professional. Common locations for the scanning stations would be the inventory room or stockroom, a nursing station within a patient floor, and in patient exam and/or patient procedure rooms, such as a cardiac catheter lab, and patient rooms.

The usage of NFC-enabled mobile devices in scanning stations to track items having RFID tags, such as medical items in a medical facility, has a number of problems.

NFC-enabled mobile devices include an NFC inductor and related circuitry installed in the back of the devices. Although NFC devices have a maximum specified range of 4 centimeters (cm), in practice, the range is typically limited to 2 cm. The magnetic field created by the primary NFC device for scanning, bounded by this range restriction, provides an active scanning area for scanning of items having RFID tags.

In addition, the location of the NFC inductor in the back of the mobile device as the primary NFC device is significant. The secondary NFC device, such as an RFID tag, must come within close proximity of the back of the mobile device (smart phone) in order to form the communications channel between the devices.

Because current scanning stations preferably mount the mobile devices as the primary NFC devices on a fixed pedestal or stand, operators would otherwise have to move the items having the RFID tags in close proximity with the back of the mobile devices in order to scan the tags. This is inconvenient and wastes time.

Moreover, the need for the RFID tag to be in close proximity of the back of the mobile device for scanning of the item makes the scanning of heavy, large, or bulky items impractical. The scanning station operator has to move the items so that the RFID tag is practically touching the back of the mobile devices in order to scan the items. This risks damaging the items, and increases occupational safety risk for operators if the items are heavy or cumbersome.

The present invention provides a passive circuit that enables the relocation of the active scanning area of the primary NFC device. The passive circuit has a primary NFC antenna placed in close proximity to the mobile device's active scanning area. The primary NFC antenna connects to a second NFC antenna, also known as the secondary NFC antenna.

The passive circuit relocates the active scanning area from the back of the mobile device to an active scanning area adjacent to the secondary NFC antenna. The antennas are tuned to the standard frequency for passive NFC, 13.56 MHz. As a result, the area in close proximity to the secondary NFC antenna becomes the active scanning area for scanning an RFID tag attached to an item.

This passive circuit is also referred to as a passive NFC repeater because the primary NFC antenna repeats, or forwards the request from the primary NFC device to the secondary NFC device via the secondary NFC antenna. The circuit is passive because it requires no native battery or power source. Instead, it receives its power from the energy induced from the NFC transceiver in the primary NFC device, such as a mobile phone.

In general, according to one aspect, the invention features a scanning station, comprising a device holder for holding an NFC transceiver device; an active scanning area for scanning of radio frequency identification (RFID) tags; and a radio frequency (“RF”) coupling system, comprising a primary NFC antenna and a secondary NFC antenna for coupling the NFC transceiver device to the active scanning area.

According to another aspect, the NFC transceiver device forms a communications channel with the RFID tags via the RF coupling system when items having the RFID tags are placed in the active scanning area. The NFC transceiver device is preferably a mobile device, such as a mobile phone or tablet computer. When a user places an item having an RFID tag in the active scanning area, the mobile device reads the information from the RFID tag using the communications channel.

In the preferred embodiment, the items are medical items having RFID tags, and the primary NFC antenna and the secondary NFC antenna are loop antennas. Preferably, a transmission line connects the primary NFC antenna and the secondary NFC antenna.

Additionally, the NFC transceiver device typically connects to a communications network. The communications network allows for two-way communication between the primary NFC device and other devices on the communications network, and receives the scanned RFID tag information forwarded from the secondary NFC antenna to the primary NFC antenna.

Preferably, the secondary NFC antenna is disposed about a horizontal plane. In the preferred embodiment, the secondary NFC antenna is mounted on a desktop or countertop of the scanning station, in the same horizontal plane as the countertop.

In other embodiments of the invention, the secondary NFC antenna is disposed about a vertical plane, and is incorporated into a paddle. Used like a hand-held wand, the paddle allows an operator to move the active scanning area to the medical item instead of moving the medical item to the active scanning area. The paddle is just one example of making the NFC secondary antenna moveable by an individual.

In yet another example, the NFC primary antenna and/or the NFC secondary antenna are designed to optimize a magnetic field of the active scanning area for scanning the RFID tags. Designing the secondary NFC antenna to have a more directional than isotropic radiation pattern, for example, can provide a benefit for specific scanning applications of items having the RFID tags.

In general, according to another aspect, the invention features a scanning station comprising a device holder for holding an NFC transceiver device; an active scanning area for scanning an NFC receiving device; and a radio frequency (“RF”) coupling system, comprising a primary NFC antenna and a secondary NFC antenna for coupling the NFC transceiver device to the active scanning area.

In another example, the NFC receiving device is a second mobile device. In one implementation, the primary NFC antenna and/or the secondary NFC antenna are designed to optimize a magnetic field within the active scanning area for scanning the RFID tags.

In general, according to yet another aspect, the invention features a method of operation of a scanning station, comprising a device holder, an active scanning area, and a radio frequency (“RF”) coupling system comprising a primary NFC antenna and a secondary NFC antenna. The method comprises holding an NFC transceiver device, scanning of radio frequency identification (RFID) tags in the active scanning area; and coupling the NFC transceiver device to the active scanning area.

In general, according to yet another aspect, the invention features a method of operation of a scanning station, comprising a device holder, an active scanning area, and a radio frequency (“RF”) coupling system comprising a primary NFC antenna and a secondary NFC antenna. The method comprises holding an NFC transceiver device, scanning of an NFC receiving device in the active scanning area; and coupling the NFC transceiver device to the active scanning area.

The above and other features of the invention including various novel details of construction and combinations of parts, and other advantages, will now be more particularly described with reference to the accompanying drawings and pointed out in the claims. It will be understood that the particular method and device embodying the invention are shown by way of illustration and not as a limitation of the invention. The principles and features of this invention may be employed in various and numerous embodiments without departing from the scope of the invention.

### BRIEF DESCRIPTION OF THE DRAWINGS

In the accompanying drawings, reference characters refer to the same parts throughout the different views. The drawings are not necessarily to scale; emphasis has instead been placed upon illustrating the principles of the invention. Of the drawings:

FIG. 1 is a schematic diagram illustrating a medical facility with scanning stations deployed in various locations in the facility and including an inventory tracking system;

FIG. 2A is a schematic diagram of the RF coupling system of the present invention, where the primary NFC device is a mobile phone or computing device, and the secondary NFC device is an RFID tag attached to a medical device;

FIG. 2B is a schematic diagram of the RF coupling system of the present invention, where the primary NFC device is a mobile phone or computing device, and the secondary NFC device is a mobile tablet device;

FIG. 3 is a schematic perspective diagram illustrating a scanning station according to the preferred embodiment of the invention;

FIG. 4 is a schematic perspective diagram illustrating a scanning station according to another embodiment of the invention; and

FIG. 5 is a schematic perspective diagram illustrating a scanning station according to yet another embodiment of the invention.

### DETAILED DESCRIPTION OF THE PREFERRED EMBODIMENTS

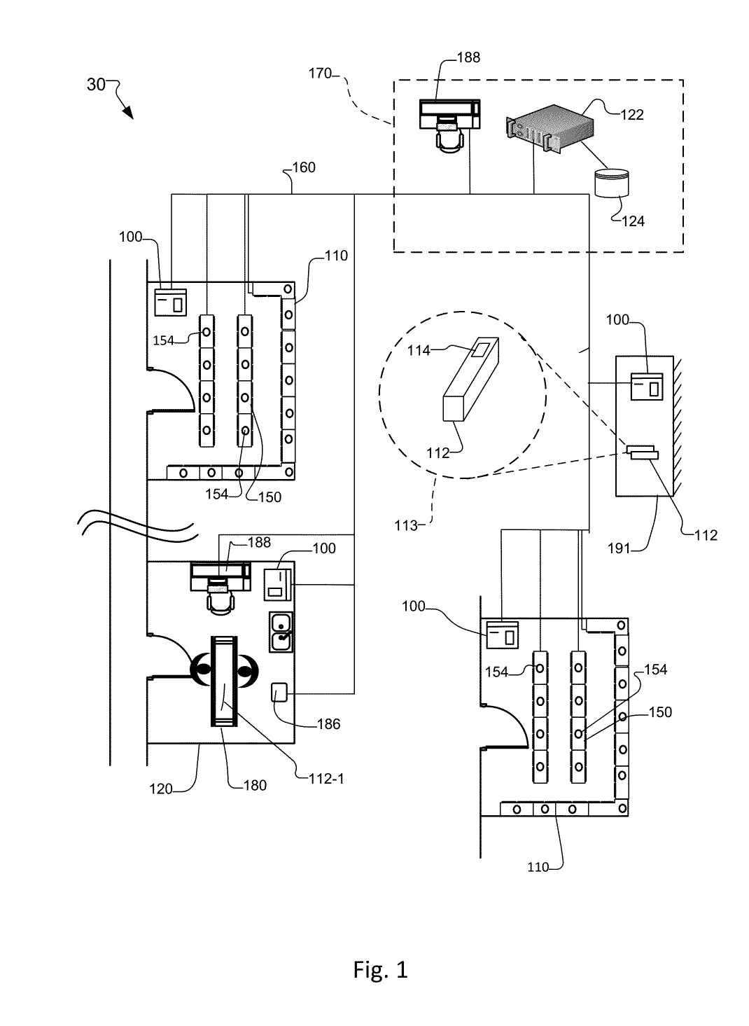

FIG. 1 illustrates a typical medical care delivery facility 30 with scanning stations 100 deployed in various locations in the facility for tracking medical items 112. The medical care delivery facility 30 is a broad category that includes facilities such as hospitals, doctors' offices, long-term care facilities, correctional facilities, and drugstores/medical supply companies. The example shows different locations that medical items 112 exist within a typical medical care delivery facility 30.

The medical devices, a subclass of medical items 112, include a broad range of devices including classes of devices such as implanted devices (e.g., cardiac stents and replacement joints and other orthopedic implants), disposables (e.g., catheters and hypodermic syringes), and equipment (e.g., imaging and monitoring devices), for example. Similarly, pharmaceuticals are another subclass of medical items 112.

The scanning stations 100 provide inventory, shipping and usage information of the medical items to an inventory management system 170. The inventory management system 170 includes a workstation 188, a server 122, and a database 124 connected to the server 122. The scanning stations 100, the workstation 188, the server 122, and the database 124 are inter-connected via a communications network 160.

A medical care delivery facility 30 typically receives medical items 112 at a loading dock 191. Personnel utilize a scanning station 100 located within the loading dock 191 for logging the initial receipt of medical items 112 with the inventory management system 170. Personnel at the medical care delivery facility 30 then transfer the medical items 112 to the appropriate medical supply rooms 110 for storage.

The expanded view 113 of a medical item 112 on the loading dock 191 shows the medical item 112 and its attached RFID tag 114. Personnel track the medical items 112 by scanning their RFID tag 114 using an RFID reader such as a scanning station 100.

The scanning stations 100 are typically installed in locations where medical items exit and enter different rooms within the medical care delivery facility 30, and where the medical items enter and exit the custody and control of different personnel groups within the medical care delivery facility 30. The inventory management system 170 records the information of each medical items provided by the scanning stations 100 and other RFID readers in the medical care delivery facility 30.

In one example, the medical supply rooms 110 comprise a number of medical supply cabinets or other storage devices 150. In one example, each of the medical supply cabinets 150 is a radio frequency identification (RFID) cabinet that includes an associated RFID reader 154. These medical supply room/cabinet readers 154 are capable of detecting and reading the RFID tags 114 of medical items 112 stored in the cabinets 150.

The RFID cabinet readers 154 of the medical supply rooms 110 are networked onto the communications network 160. Specifically, the cabinet readers 154 communicate via the communications network 160 to the inventory management system 170. In this way, the inventory management system 170 is able to track the presence of the medical items 112 in the storage cabinets 150 in real-time without intervention by staff Thus, no action is required by the hospital personnel in order to enable the inventory management system 170 to detect the presence of the medical items 112. Further, there is no staff intervention required when medical items 112 are removed since the periodic scans of the cabinet contents by the readers 154 detect removal, which is then reported to the inventory management system 170. Finally, this inventory tracking system, being RFID-based, is able to track each item in inventory, uniquely, according to the unique serial number encoded in each RFID tag.

In other examples, the medical supply room 110 has standard medical supply cabinets or other storage units, which do not have integrated RFID readers. In this example, the medical supply rooms 110 include one or more scanning stations 100 for performing manual inventory transactions of medical items in the room.

In yet another example, the medical supply rooms 110 include the RFID-enabled medical supply cabinets 150 and the scanning stations 100. The scanning stations 100 allow scanning of such medical items 112 as medical items that require specialized care and control, and items that cannot otherwise be stored in the RFID-enabled medical supply cabinets 150.

Personnel remove the medical items 112 from the medical supply rooms 110 for transfer to a procedure room 120. In some examples, these procedure rooms 120 are simply patient examining rooms for simple procedures such as injections. In other examples, the procedure room 120 is an operating room, a diagnostic or monitoring room, or a dedicated-use room such as a catheterization laboratory (cathlab), or control room for a cathlab. In other examples, the procedures are performed in interventional radiology rooms, electro-physiology rooms and/or rooms for orthopedics.

Each procedure room 120 preferably includes one or more scanning stations 100. Personnel utilize the scanning stations 100 to detect the usage of the medical items 112 in the context of the procedure being performed by medical professionals, on a patient on a table 180. In the illustrated example, the procedure room 120 has medical item 112-1, a catheter, awaiting insertion in a patient on the table 180.

The procedure room 120 also has an RFID reader associated with a refuse container system 186 and/or an RFID reader associated with a workstation 188. When an RFID tag 114 of a medical item 112 in a procedure room 120 is scanned by a scanning station 100 or other RFID reader, the medical item 112 is assumed to have been used or consumed.

The medical items 112, e.g., medical devices and pharmaceuticals, reach the point of consumption in procedure rooms 120 at the medical care delivery facilities 30. Thus, in this example, the inventory management system 170 tracks the movement of medical items 112, including medical devices and pharmaceuticals, through the entire chain of custody and control in the medical care delivery facility 30. The inventory management system 170 maintains this information in the database 124 via the server 122.

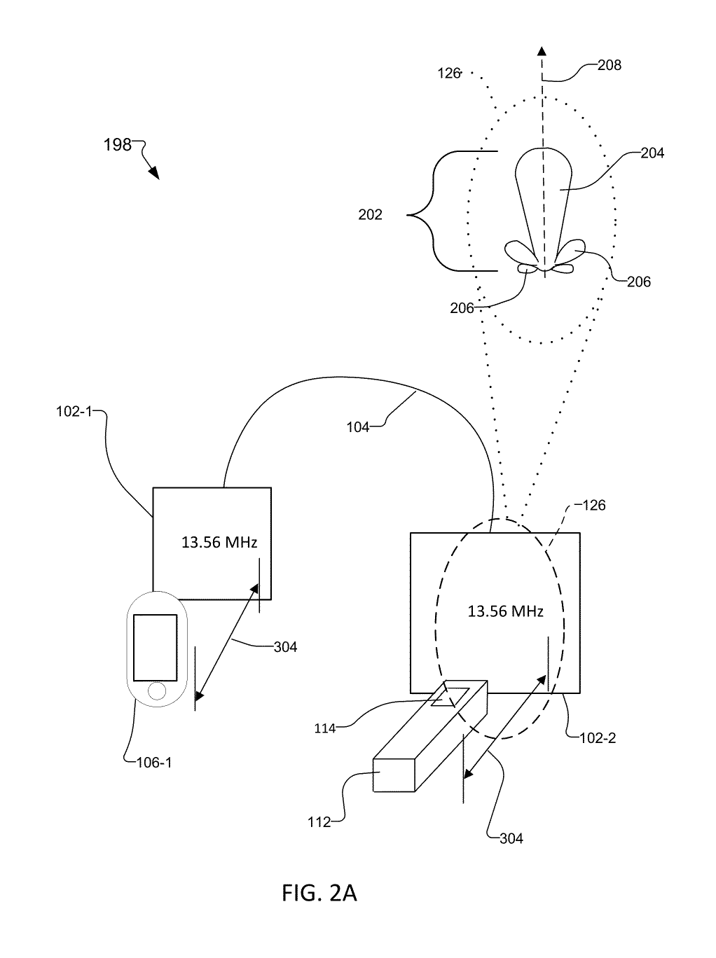

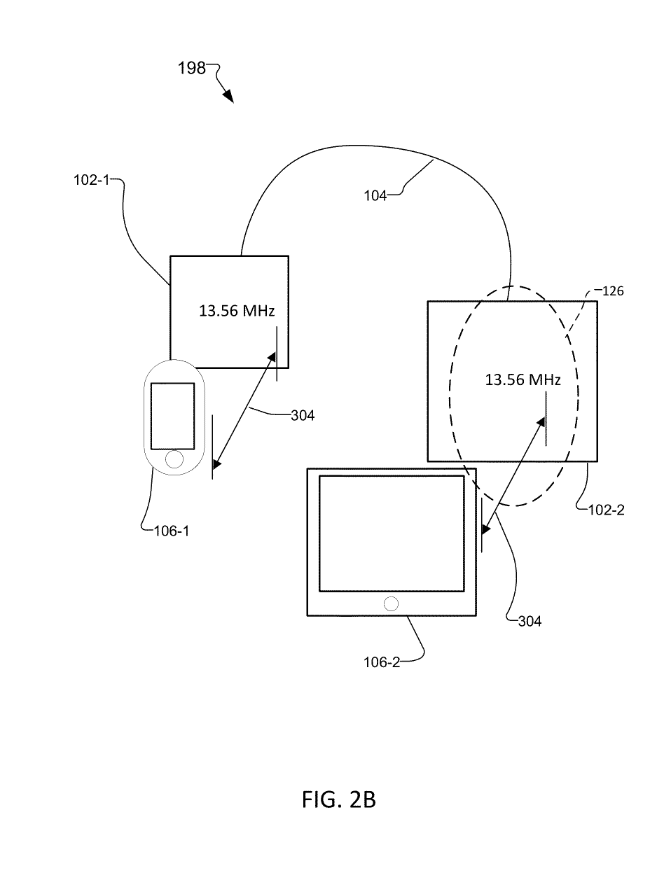

FIG. 2A shows an exemplary RF coupling system 198 of the scanning station 100 with a mobile phone 106-1 as the primary NFC device, and an RFID tag 114 attached to a medical item 112 as the secondary NFC device. The RF coupling system 198 includes a primary NFC antenna 102-1 and a secondary NFC antenna 102-2 preferably connected via a transmission line 104. Both the primary NFC antenna 102-1 and the secondary NFC antenna 102-2 are tuned to the standard frequency for passive NFC, 13.56 MHz.

For passive communications, an NFC transceiver device as the primary NFC device initiates communication with a secondary NFC device by providing a carrier magnetic field that includes the communication information. The secondary NFC device answers by modulating the magnetic field provided by the primary NFC device. This creates a wireless communication link between the devices.

In the example, the primary NFC device and the secondary NFC device connect via the RF coupling system 198. The RF coupling system 198 provides the mutual coupling between the primary NFC device and the secondary NFC device, and therefore the communication link between the primary NFC device and the secondary NFC device.

In more detail, the primary NFC device first creates mutual coupling between the primary NFC device and the NFC primary antenna 102-1. This occurs when the primary NFC device is transmitting a request and is within range of the NFC primary antenna 102-1. This range is the device-to-antenna distance 304, which is typically 2 cm or less. The mutual coupling induces a current in the NFC primary antenna 102-1. Then, the NFC primary antenna 102-1 transmits the signal associated with the induced current over the transmission line 104 to the secondary NFC antenna 102-2.

The secondary NFC antenna 102-2, in response, generates a carrier magnetic field 202 associated with the signal. When a user places the secondary NFC device within range of the secondary NFC antenna 102-2, mutual coupling is created between the secondary NFC antenna 102-2 and the secondary NFC device. The range of the magnetic field 202 between the secondary NFC antenna 102-2 and the secondary NFC device is also known as the active scanning area 126.

The range of the active scanning area 126 is the device-to-antenna distance 304. Like the range between the primary NFC device and the NFC primary antenna 102-1, the active scanning area 126 includes a magnetic field 202 whose range is typically no more than 2 cm between any two points on the secondary NFC antenna 102-2 and the secondary NFC device.

As a result, the secondary NFC device, the RFID tag 114 attached to the medical item 112, forms a communication link with the primary NFC device, mobile phone 106-1 or other mobile computing device 106, via the RF coupling system 198. The RFID tag 114 attached to the medical item 112 provides its information in response to the request from the mobile device 106.

Preferably, the primary NFC antenna 102-1 and the NFC secondary antenna 102-2 are loop antennas. Unlike ferrite antennas, loop antennas are simpler to construct, and are much less expensive to produce. In one example, the loop antennas are optimized within a plastic carrier or substrate that provides durability. In another example, the loop antennas are stamped onto a printed circuit board.

Because reading the RFID tags 114 is accomplished through inductive coupling between coils of wire, the size and/or shape active field or active scanning area 126 is dependent on the same factors that apply to the design of inductively coupled transformers. Design factors of the NFC primary antenna 102-1 and NFC secondary antenna 102-2 include the number of coil turns, diameter of the coils, proximity of the coils, material of the coils, and nearby dielectric materials. These factors influence field strength and inductive coupling, and as a result, affect the field shape and extent of the active scanning area 126.

As a result, changes to the design of the primary NFC antenna 102-1 and/or the secondary NFC antenna 102-2 of the RF coupling system 198 provide an additional benefit. The benefit is the ability to optimize the active scanning area 126 for a particular scanning application, such as when a different shape of the magnetic field 202 within the active scanning area 126 is required.

In a preferred embodiment, such as the RF coupling system 198 of FIG. 2A, the RF coupling system 198 is asymmetric. Using a larger sized NFC secondary antenna 102-2 as compared to the NFC primary antenna 102-1 has shown experimentally to optimize field strength and read distance of the active scanning area 126, without adding external sources of power. In addition, increasing the number of coil turns in the secondary NFC antenna 102-2 relative to the primary 102-1 is also desirable in some instances.

Moreover, designing the NFC primary antenna 102-1 and or the NFC secondary antenna 102-2 in response to specific scanning applications of the RFID tags 114 can provide a benefit. For example, designing the NFC secondary antenna 102-2 to be more directional than isotropic in nature is usually useful when scanning RFID tags 114 located on mostly the same type of item or similarly-sized items.

In the embodiment of FIG. 2A, the NFC secondary antenna 102-2 has been designed for optimizing its magnetic field 202 within the active scanning area 126 for a specific application of the RF coupling system 198. As a result of the design of the NFC secondary antenna 102-2, its magnetic field 202 within the active scanning area 126 is more directional than isotropic in nature. The magnetic field 202 includes main lobe 204 and side lobes 206. The main lobe 204 is oriented in direction 208. The direction 208, in one example, is associated with a scanning application that expects RFID tags 114 to be located mostly near the center of the active scanning area 126 during scanning.

In other examples, varying (increasing or decreasing) the size of the antennas 102 and their number of coils can also be used to change the shape and size of the magnetic field 202 in the active scanning area 126.

FIG. 2B shows another embodiment of the RF coupling system 198 of the scanning station 100, with mobile devices 106 as the primary NFC device and the secondary NFC device. The elements and their function in FIG. 2B are nearly identical to those in FIG. 2A, with the exception that the secondary NFC device is a mobile device 106, tablet 106-2.

In the example, the secondary NFC device, tablet 106-2 forms a communication link with the primary NFC device, mobile phone 106-1, via the RF coupling system 198. The tablet 106-2 provides information in response to the request from the mobile phone 106-1.

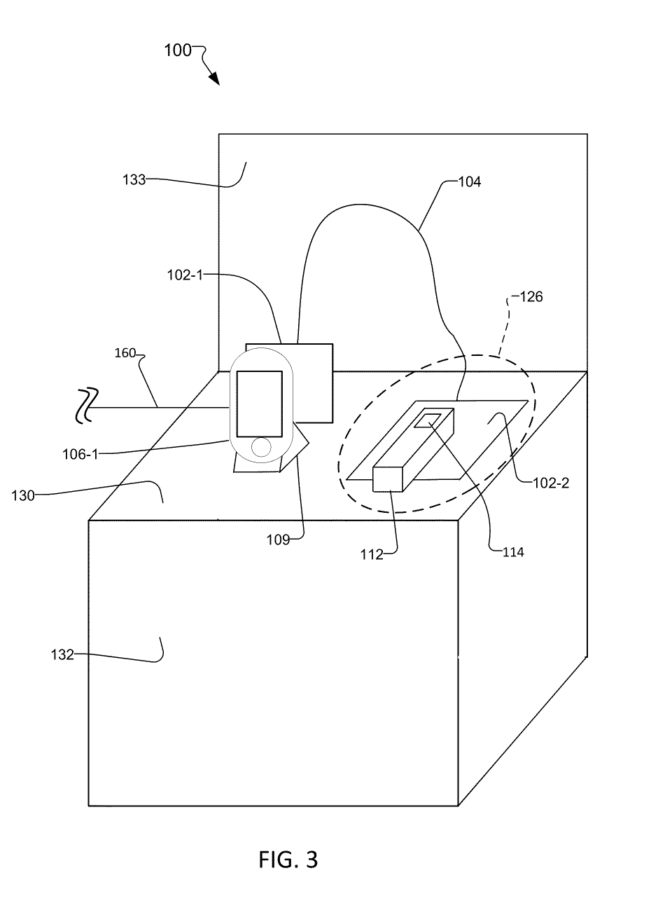

FIG. 3 illustrates the preferred embodiment of the scanning station 100. In the example, the scanning station 100 preferably includes a countertop 130 that sits on top of a cabinet 132. In one example, the cabinet 132 also includes a back portion or member 133 for added stability.

The RF coupling system 198 is positioned on the countertop 130. The primary NFC device, mobile phone 106-1, is held by a device holder 109 attached to the countertop 130. The NFC primary antenna 102-1 of the RF coupling system 198 is also attached to the countertop 130. The NFC primary antenna 102-1 is preferably disposed in a vertical plane.

NFC primary antenna 102-1 and the device holder 109 are preferably attached to the countertop 130 in a plane perpendicular to the surface of the countertop 130. This enables the NFC primary antenna 102-1 and the mobile phone 106-1 to be oriented optimally within the device-to-antenna distance 304 for maximum transmission efficiency.

The NFC secondary antenna 102-2 of the RF coupling system 198 is preferably disposed in a horizontal plane. In the example, the NFC secondary antenna 102-2 is mounted to the countertop 130, in the same plane as the countertop 130. This enables the active scanning area 126 to be within the same plane as the countertop 130, making scanning of the medical items 112 easier for personnel.

Personnel perform scanning of the medical items 112 by placing the RFID tag 114 of the medical items 112 within the active scanning area 126. In response to the scan, the NFC secondary antenna 102-2 provides the information from the RFID tag 114 over the communications link formed by the mobile phone 106-1, the RF coupling system 198, and the RFID tag 114.

The NFC secondary antenna 102-2 forwards the information from the RFID tag 114 over transmission line 104 to the NFC primary antenna 102-1, which in turn, transmits the information to the mobile phone 106-1. Then, the mobile phone 106-1 or other computing device 106 provides the information via the communications network 160 to the inventory management system 170.

The transmission line 104 also increases the effective communication distance between the primary NFC device and the secondary NFC device beyond the typical 2 cm or 4 cm device-to-antenna distance 304 as compared to current scanning stations and methods. Given the NFC frequency of 13.56 MHz, the maximum wavelength of NFC is the speed of light divided by the frequency, or ˜22 meters.

A transmission line 104 whose impedance is optimally matched to the impedance of the NFC primary antenna 102-1 and the NFC secondary antenna 102-2 provides faithful reproduction of NFC signals from the primary NFC device and the secondary NFC device with minimal signal loss.

By utilizing the transmission line 104, the effective communication distance between the primary NFC device and the secondary NFC device for scanning station 100 is now on the order of meters, as opposed to centimeters. This enables new applications for operators utilizing NFC-based scanning stations 100, and provides operators with more flexibility when scanning medical items 112.

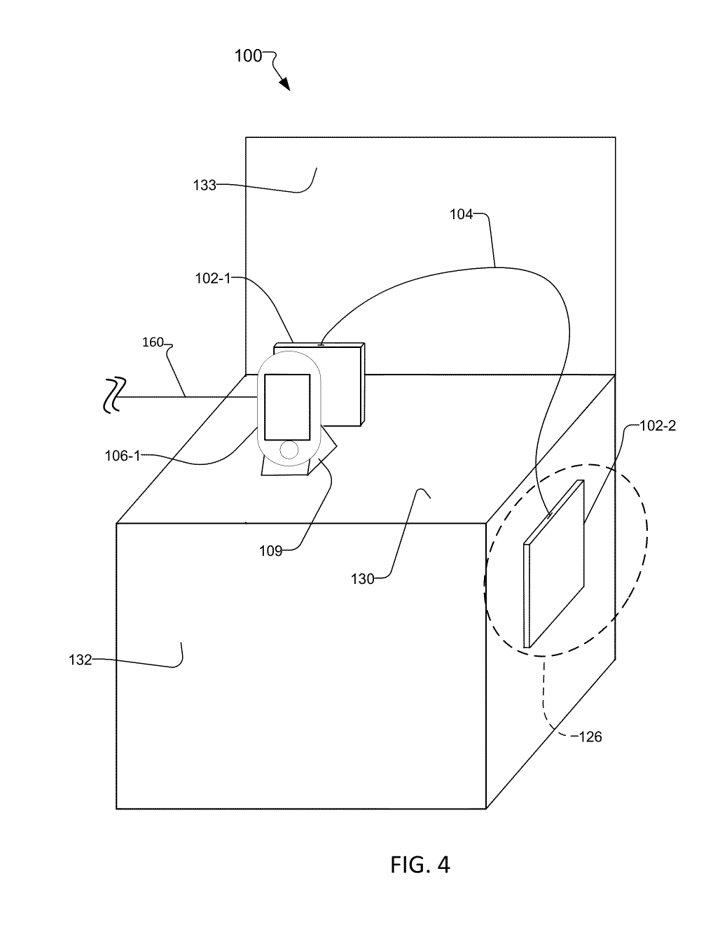

FIG. 4 illustrates another embodiment of the scanning station 100. The elements and their function in FIG. 4 are nearly identical to those in FIG. 3, with the exception that the NFC secondary antenna 102-2 is disposed in a vertical plane, attached to the side of the cabinet 132.

Positioning the NFC secondary antenna 102-2 in this way relocates the active scanning area 126 to the side of the cabinet 132. This allows the operator of the scanning station 100 to scan large or heavy medical items that would be impractical or impossible to scan using the example in FIG. 3.

In one example, the scanning station 100 provides the ability to track large medical instrumentation components placed on a rolling table or hand cart. Operators roll the hand cart containing the medical items 112 by the side of the cabinet 132 where the NFC secondary antenna 102-2 is mounted. The scanning station scans the RFID tag 114 of the medical items 112 without requiring the operator to remove the medical items 112 from the hand cart.

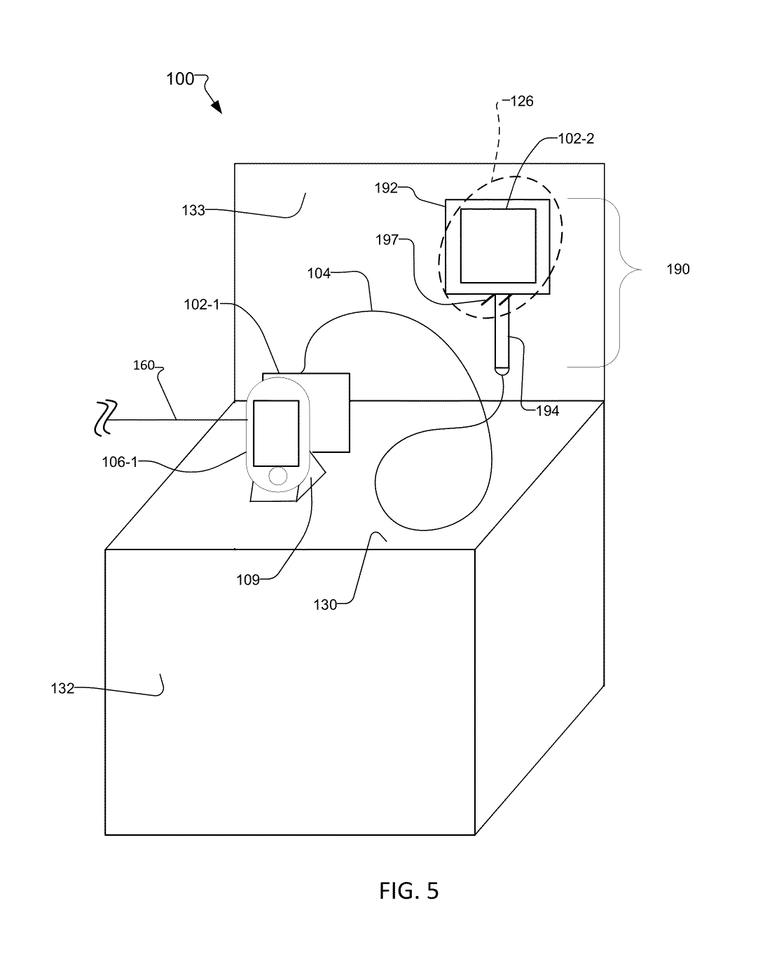

FIG. 5 illustrates yet another embodiment of the scanning station 100, where the NFC secondary antenna 102-2 is moveable by an individual The elements and their function in FIG. 4 are substantially identical to those in FIG. 3 and FIG. 4. However, the example takes the most advantage of the increased effective distance between the primary NFC device and the secondary NFC device that the transmission line 104 of the RF coupling system 198 provides.

In the example, the NFC secondary antenna 102-2 is incorporated within a hand-held wand device, or paddle 190. The paddle 190 facilitates movement of the NFC secondary antenna 102-2 by an individual for scanning items having RFID tags 114. The paddle 190 is not attached to the scanning station 100. Instead, the paddle hangs on a hook 197, and the hook 197 is attached to the back member 133 of the scanning station 100.

The paddle 190 includes a handle 194, and a blade 192. The NFC secondary antenna 102-2 preferably is incorporated into the blade 192 of the paddle 190. Preferably, the handle 194 has a hole, or hollowed-out portion about its main axis that allows the transmission line 104 of the RF coupling system 198 to connect through the handle 194 to the NFC secondary antenna 102-2.

The paddle 190 extends the capabilities of the example in FIG. 4 for scanning large or heavy items, and also increases the effective range of the active scanning area 126 as compared to the examples in FIG. 3 and FIG. 4.

In the example, to scan a medical item 112, the operator removes the paddle 190 from the hook 197, and brings the side of the blade 192 having the NFC secondary antenna 102-2 within the device-to-antenna distance 304 of the RFID tag 114 of the medical item 112.

The flexibility provided by the paddle 190 provides for remote scanning of medical items 112 located at a distance on the order of meters away from the scanning station 100. Moreover, the paddle 190 allows the operator to relocate the active scanning area 126 to the medical item 112, instead of the operator bringing the medical item 112 to be within the active scanning area 126, as in the examples of FIG. 3 and FIG. 4.

While this invention has been particularly shown and described with references to preferred embodiments thereof, it will be understood by those skilled in the art that various changes in form and details may be made therein without departing from the scope of the invention encompassed by the appended claims.

What is claimed is:

1. A scanning station system, comprising:
a device holder for holding an NFC transceiver device;
an active scanning area for scanning of radio frequency identification (RFID) tags; and
a radio frequency (“RF”) coupling system, comprising a primary NFC antenna and a secondary NFC antenna for coupling the NFC transceiver device to the active scanning area.

2. The system of claim 1, wherein the NFC transceiver device forms a communications channel with the RFID tags via the RF coupling system when items having the RFID tags are placed in the active scanning area.

3. The system of claim 2, wherein the items are medical items.

4. The system of claim 1, wherein the primary NFC antenna and the secondary NFC antenna are loop antennas.

5. The system of claim 1, wherein the NFC transceiver device connects to a communications network.

6. The system of claim 1, wherein the scanning station scans medical items, each of the medical items having the RFID tags.

7. The system of claim 1, wherein the secondary NFC antenna is disposed about a horizontal plane.

8. The system of claim 1, wherein the secondary NFC antenna is disposed about a vertical plane.

9. The system of claim 1, wherein the secondary NFC antenna is incorporated into a paddle.

10. The system of claim 1, wherein the secondary NFC antenna is moveable by an individual.

11. The system of claim 1, wherein a transmission line connects the primary NFC antenna and the secondary NFC antenna.

12. The system of claim 1, wherein the NFC transceiver device is a mobile device.

13. The system of claim 1, wherein the primary NFC antenna and/or the secondary NFC antenna are designed to optimize a magnetic field within the active scanning area for scanning the RFID tags.

14. A scanning station system, comprising:
a device holder for holding an NFC transceiver device;
an active scanning area for scanning an NFC receiving device; and
a radio frequency (“RF”) coupling system, comprising a primary NFC antenna and a secondary NFC antenna for coupling the NFC transceiver device to the active scanning area.

15. The system of claim 14, wherein the NFC receiving device is a mobile device.

16. A method of operation of a scanning station, comprising a device holder, an active scanning area, and a radio frequency (“RF”) coupling system comprising a primary NFC antenna and a secondary NFC antenna, the method comprising:
holding an NFC transceiver device;
scanning of radio frequency identification (RFID) tags in the active scanning area; and
coupling the NFC transceiver device to the active scanning area.

17. The method of claim 16, further comprising forming a communications channel with the RFID tags by placing items having the RFID tags in the active scanning area.

18. The method of claim 16, further comprising connecting the NFC transceiver device to a communications network.

19. The method of claim 16, further comprising scanning medical items, each of the medical items having the RFID tags.

20. The method of claim 16, further comprising disposing the secondary NFC antenna about a horizontal plane.

21. The method of claim 16, further comprising disposing the secondary NFC antenna about a vertical plane.

22. The method of claim 16, further comprising incorporating the secondary NFC antenna into a paddle.

23. The method of claim 16, further comprising enabling the secondary NFC antenna to be moveable by an individual.

24. The method of claim 16, further comprising designing the primary NFC antenna and/or the secondary NFC antenna to optimize a magnetic field within the active scanning area for scanning the RFID tags.

25. The method of claim 16, further comprising connecting the primary NFC antenna and the secondary NFC antenna.

26. A method of operation of a scanning station, comprising a device holder, an active scanning area, and a radio frequency (“RF”) coupling system comprising a primary NFC antenna and a secondary NFC antenna, the method comprising:
holding an NFC transceiver device;
scanning an NFC receiving device in the active scanning area; and
coupling the NFC transceiver device to the active scanning area.
